(19) United States
(12) Patent Application Publication
(10) Pub. No.: US 2012/0177173 A1
(43) Pub. Date: Jul. 12, 2012

(54) METHOD AND APPARATUS FOR REDUCING IMAGING ARTIFACTS

(75) Inventors: DAN XU, WAUKESHA, WI (US); JIANG HSIEH, BROOKFIELD, WI (US); MASATAKE NUKUI, HINO-SHI (JP); PAAVANA SAINATH, OCONOMOWOC, WI (US)

(73) Assignee: GENERAL ELECTRIC COMPANY, SCHENECTADY, NY (US)

(21) Appl. No.: 12/986,398

(22) Filed: Jan. 7, 2011

(51) Int. Cl. H05G 1/60; G06K 9/40

(52) U.S. Cl. 378/19; 382/260

(57) ABSTRACT

A method for reducing imaging artifacts includes preprocessing a computed tomography (CT) projection data set to generate preprocessed CT projection data, filtering the preprocessed CT projection data using a mean-preserving filter (MPF) to reduce electronic noise, generating a sinogram using the filtered CT projection data, performing a minus logarithmic operation on the sinogram to generate a noise corrected image, and displaying the noise corrected image on a display. A imaging correcting module and a multi-modality imaging system are also described herein.

### BACKGROUND OF THE INVENTION

This subject matter disclosed herein relates generally to imaging systems, and more particularly to a method and apparatus for reducing imaging artifacts and improving the quality of medical images.

Reducing imaging artifacts has become an increasingly important issue for medical imaging. Imaging artifacts occur for several reasons, such as, for example, if the raw X-ray beam at the detectors is weak. Such a condition is known as X-ray photon starvation. Since X-ray photons are absorbed by the human body, the strength (or magnitude) of the X-ray beam is reduced as the beam travels through the body. Accordingly, X-ray photon starvation occurs most often when the X-ray beam must travel through a lengthy region of a patient's body causing a reduction in the photon flux. Photon flux represents the quantity of photons reaching the detector over a predetermined time, which is also referred to herein as the raw count from the detector.

Two types of artifacts are commonly associated with X-ray photon starvation conditions. One artifact type is known as “streaking”. Streaking is caused by the noise boost from a negative log operation applied to the raw imaging data. Another artifact type is known as “shading”. Shading artifacts occur when the photon flux drops to a level that is below the noise level of the detector acquisition system (DAS) electronic noise.

Adaptive filtering techniques have been proposed to correct projection data for streak artifacts. One such technique utilizes a “smoothing” operation. “Smoothing” operations generally involve adjusting the signal detected at one channel based on the detected signal magnitude at the channel and the magnitudes of the detected signals of adjacent channels. Such “smoothing” is performed on a channel by channel basis to eliminate streaking type artifacts. However, conventional smoothing algorithms are not adapted to compensate for shading artifacts.

Moreover, when the DAS measurement of the X-ray beam drops below zero, the negative measurements must be treated before the negative log operation. Conventional imaging systems simply clip the negative measurements or replace the negative measurements by an absolute value. However, clipping or replacing the negative measurements generates a bias in the final pre-processed sinogram which results in additional shading artifact being introduced into a reconstructed image.

### BRIEF DESCRIPTION OF THE INVENTION

In one embodiment, a method for reducing imaging artifacts is provided. The method includes preprocessing a computed tomography (CT) projection data set to generate preprocessed CT projection data, filtering the preprocessed CT projection data using a mean-preserving filter (MPF) to reduce electronic noise, generating a sinogram using the filtered CT projection data, performing a minus logarithmic operation on the sinogram to generate a noise corrected image, and displaying the noise corrected image on a display.

In another embodiment, an image artifact reducing module is provided. The image artifact reducing module is programmed to receive preprocessed computed tomography (CT) projection data including a plurality of detector output signals, filter the preprocessed CT projection data using a mean-preserving filter (MPF) to reduce electronic noise, generate a sinogram using the filtered CT projection data, and perform a minus logarithmic operation on the sinogram to generate a noise corrected image.

In a further embodiment, a multi-modality imaging system is provided. The multi-modality imaging system includes a first modality unit, a second modality unit, and a computer operationally coupled to the first and second modality units. The computer is programmed to receive preprocessed computed tomography (CT) projection data including a plurality of detector output signals, filter the preprocessed CT projection data using a mean- preserving filter (MPF) to reduce electronic noise, generate a sinogram using the filtered CT projection data, and perform a minus logarithmic operation on the sinogram to generate a noise corrected image.

### BRIEF DESCRIPTION OF THE DRAWINGS

FIG. 1 is a pictorial view of an exemplary imaging system formed in accordance with various embodiments.

FIG. 2 is a flowchart illustrating an exemplary method for correcting projection data in accordance with various embodiments.

FIG. 3 is a graphical illustration of an exemplary mapping function in accordance with various embodiments.

FIG. 4 is a block schematic diagram of an exemplary distribution function in accordance with various embodiments.

FIG. 5 is a block schematic diagram of another exemplary distribution function in accordance with various embodiments.

FIG. 6 is a pictorial view of an exemplary multi-modality imaging system fonned in accordance with various embodiments.

FIG. 7 is a block schematic diagram of the system illustrated in FIG. 6.

### DETAILED DESCRIPTION OF THE INVENTION

The foregoing summary, as well as the following detailed description of various embodiments, will be better understood when read in conjunction with the appended drawings. To the extent that the figures illustrate diagrams of the functional blocks of the various embodiments, the functional blocks are not necessarily indicative of the division between hardware circuitry. Thus, for example, one or more of the functional blocks (e.g., processors or memories) may be implemented in a single piece of hardware (e.g., a general purpose signal processor or a block of random access memory, hard disk, or the like) or multiple pieces of hardware. Similarly, the programs may be stand alone programs, may be incorporated as subroutines in an operating system, may be functions in an installed software package, and the like. It should be understood that the various embodiments are not limited to the arrangements and instrumentality shown in the drawings.

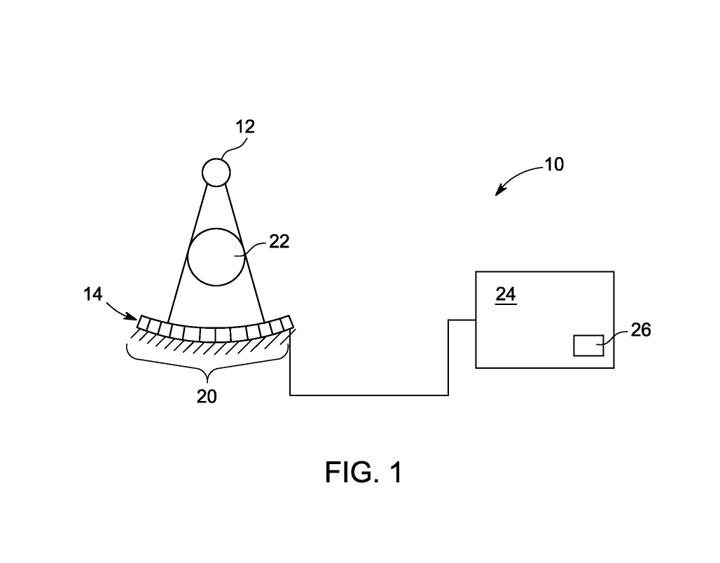

FIG. 1 illustrates a simplified block diagram of an exemplary imaging system 10 that is formed in accordance with various embodiments. In the exemplary embodiment, the imaging system 10 is a computed tomography (CT) imaging system that includes an X-ray source 12 and a detector 14. The detector 14 includes a plurality of detector elements 20, that are arranged in rows and channels, that together sense projected X-rays, from the X-ray source 20, that pass through an object, such as a patient 22. Each detector element 20 produces an electrical signal, or output, that represents the intensity of an impinging X-ray beam and hence allows estimation of the attenuation of the beam as the beam passes through the patient 22. The imaging system 10 also includes a computer 24 that receives the projection data from the detector 14, also referred to herein as raw data, and processes the projection data to reconstruct an image of the object 22. In various embodiments, the computer 24 may include an image artifact reducing module 26 that is programmed to reduce and or eliminate imaging artifacts that may cause shading and/or streaking to occur in a reconstructed image.

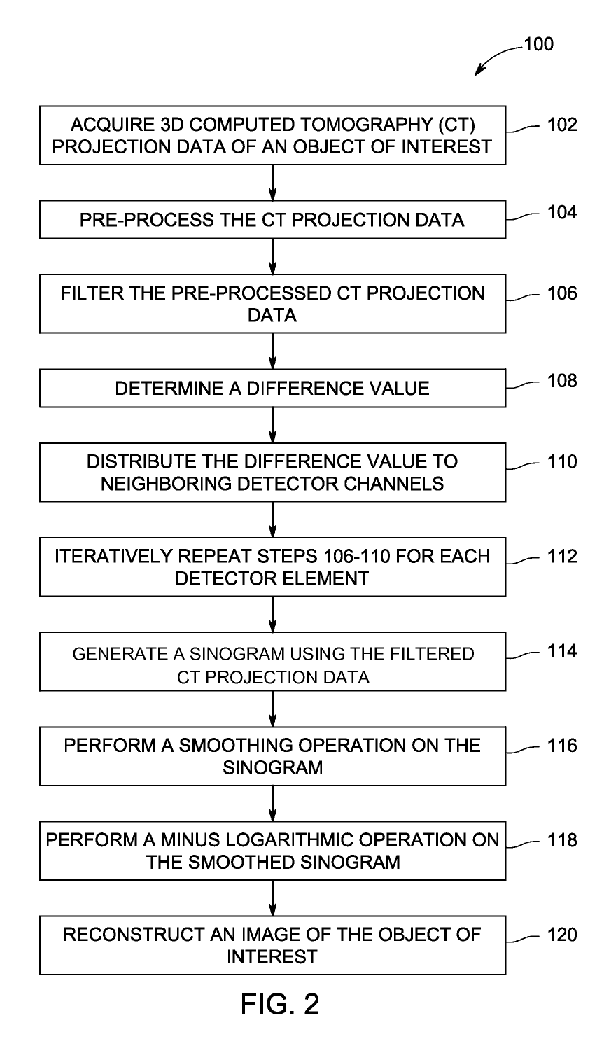

FIG. 2 is a flowchart of an exemplary method 100 for reducing image artifacts that are caused as a result of, for example, photon starvation. The method 100 may be embodied as a set of instructions that are stored on the computer 24 and implemented using the image artifact reducing module 26, for example. In various embodiments, the method 100 corrects both streak artifacts and shading artifacts using an adaptive 3D smoothing algorithm.

At 102, a plurality of computed tomography (CT) projection data is acquired. The CT projection data may be acquired from the imaging system 10 shown in FIG. 1. Optionally, the CT projection data may be acquired from a memory device configured to store projection data from previous imaging scans.

At 104, the CT projection data is preprocessed to generate preprocessed CT projection data. In the exemplary embodiment, preprocessing the CT projection data may include, for example, applying a detector gain-calibration, a reference channel normalization, and/or other suitable corrections to the CT projection data. Preprocessing the CT projection data may also include applying a scatter correction or using various other techniques to preprocess the CT projection data.

As discussed above, reducing the tube current value or voltage value to reduce patient dosage, may result in the projection data including at least some negative signals. More specifically, electronic noise caused by the detector or a data acquisition system (DAS) coupled to the detector, may result in low signals when the x-ray source 12 current or voltage is reduced to a point that causes photon starvation. A low signal is a signal that includes a plurality of photon counts that is approximately equal to, or the same magnitude as, the noise level of the DAS system. A negative signal is one example of a low signal. The negative signals must be turned into positive values prior to a log operation being performed on the projection data to form a reconstructed image, because the log operation cannot take negative values as input.

Accordingly, at 106 the pre-processed projection data acquired from 104 is filtered to reduce the impact of the electronic noise that results in shading artifacts in a reconstructed image. In the exemplary embodiment, filtering at 106 is accomplished using a mean-preserving filter (MPF). In operation, the MPF assigns each negative sample a predetermined value while changing the values of the sample's neighbors at the same time to keep the mean values substantially the same. More specifically, the MPF is configured to replace detector samples having a negative value with a predetermined positive value while preserving the local mean value of the remaining detector samples. Accordingly, detector samples having negative values are replaced with a positive value, and the shift caused by this replacement is distributed to the neighboring detector channels, such that no bias will be introduced.

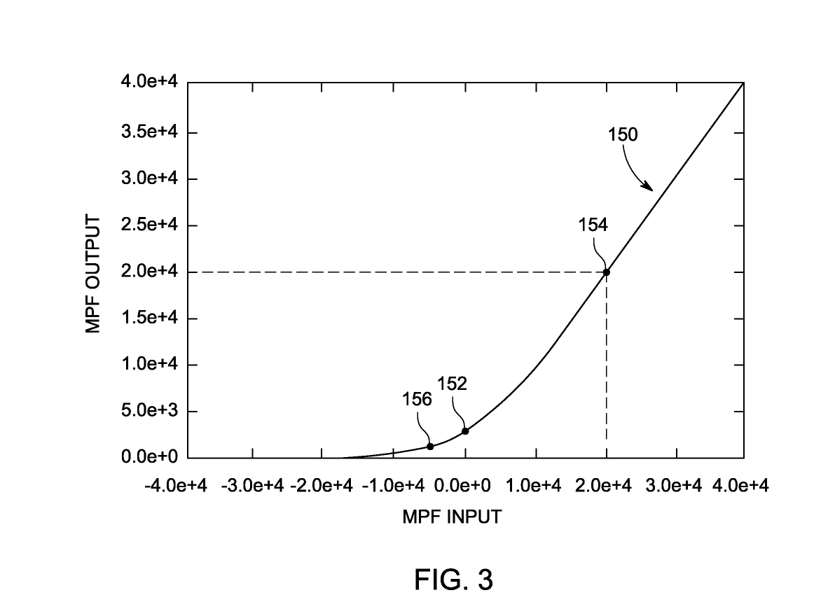

In the exemplary embodiment, the MPF utilizes a mapping function to identify detector elements 20 outputting negative values. FIG. 3 is a graphical illustration of an exemplary mapping function utilized by the MPF filter wherein the X-axis represents the detector element output value being input to the MPF filter. It should be realized that the detector element output value represents the output from a detector element after the detector element output has been subjected to the preprocessing step denoted at 102. The Y-axis represents the output from the MPF filter. As shown in FIG. 3, a line 150 represents the value assigned to the outputs of the detector elements. In one embodiment, when a detector element output is greater than or equal to zero, denoted as a point 152, the MPF filter output is equal to the MPF filter input. For example, assuming that a detector element output is approximately 2.0^{e4}, then the MPF filter output, denoted as a point 154 is also approximately 2.0^{e4}. Moreover, assuming that a detector element output is less than zero, then the MPF filter output assigns the input a positive value. For example, assuming that the MPF filter input is approximately −0.5^{e4}, then the MPF filter assigns a new value of also approximately +0.25^{e4}, which is denoted as a point 156. In each case, a detector element output having a negative value is assigned, or mapped, to a positive value that is greater than zero.

The line 150, shown in FIG. 3, may be expressed mathematically as:

$${MPF}_{Output} \{ σ log ( \begin{matrix}{σe}^{{MPF}_{Input} / σ} \\ {e}^{{MPF}_{Input / σ}} + 1 \\ {MPF}_{Input}\end{matrix} ) \begin{matrix}{ifMPF}_{Input} \leq - trsd \\ if - trsd < {MPF}_{Input} \leq trsd \\ {ifMPF}_{Input} > trsd\end{matrix} \qquad Equation 1$$

wherein: MPF_{Output} is the corrected value output from the MPF filter;

MPF_{Input} is the value input to the MPF filter;

σ is the value of the electronic noise;

trsd is a threshold value that is derived in accordance with σ*cutoff; and

cutoff is a tuning parameter. The cutoff value may be selected by the operator. Optionally, the cutoff value may be automatically set by the imaging system 10. For example, the cutoff value may be selected as 4 such that the threshold value (trsd) is set to 4σ. It should be realized that threshold value (trsd) is utilized to identify certain detector element outputs that are to be assigned a new value by the MPF filter. For example, assuming that the MPF_{Input} is >trsd, then the MPF_{Output} is set equal to the MPF_{Input}. Otherwise, the MPF_{Output} is assigned a value based on Equation 1. It should be realized that the values assigned by the MPF filter in Equation 1 are exemplary, and that the MPF filter may be modified to assign different values than the values shown in Equation 1.

At 108 a difference (ε) between the MPF filter input value and the MPF filter output value is determined in accordance with:

ε=MPF_{Output}−MPF_{Input} Equation 2

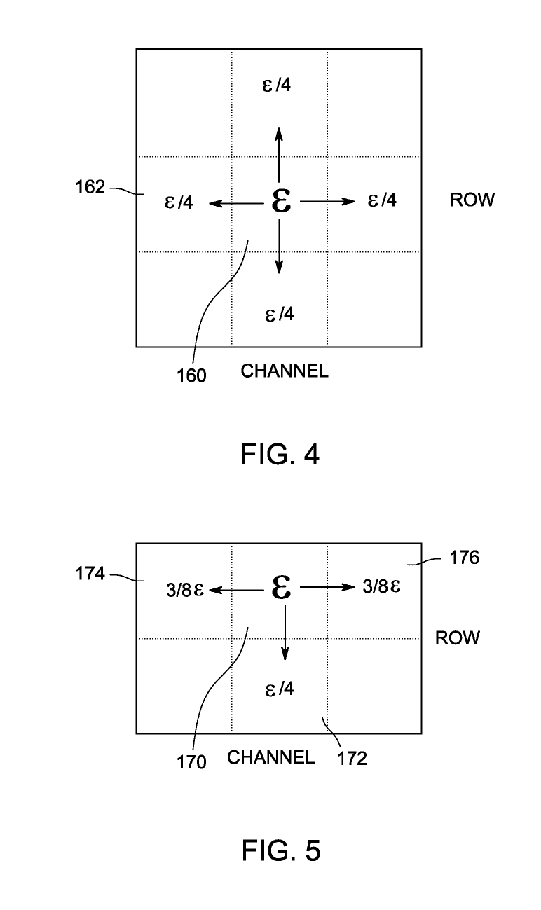

At 110, the difference calculated at 108 is distributed, or propagated, to neighboring detector channels as shown in FIG. 4. For example, assume that the MPF mapping function has been performed on a pixel or detector element 162 in accordance with step 106. Moreover, assume that the difference between the MPF_{Output} and the MPF_{Input} has been determined in accordance with step 108, then at 110, the difference value (c) determined at 108 is distributed to at least some of the neighboring pixels. In the exemplary embodiment, the difference value (c) is distributed to neighboring pixels by multiplying the output from the neighboring pixel by a portion of the difference value (c). In the exemplary embodiment of FIG. 4, each of the neighboring pixels is corrected in accordance with ε/n, wherein n is the quantity of neighboring pixels being corrected. For example, as shown in FIG. 4, four neighbors surrounding the pixel 162 are being corrected. Therefore, the output from each neighboring pixel is multiplied by ε/4.

At 110, the difference calculated at 108 may also be distributed, or propagated, to neighboring detector channels as shown in FIG. 5. In the exemplary embodiment, the distribution illustrated in FIG. 4 is utilized for detector elements 20 that are spaced away from the edge of the detector 14. Whereas, the distribution illustrated in FIG. 5 is utilized for detector elements 20 that form the edge of the detector 14. For example, assume that the MPF mapping function has been performed on a pixel or detector element 170 in accordance with step 106. Moreover, assume that the difference between the MPF_{Output} and the MPF_{Input} has been determined in accordance with step 108, then at 110, the difference value (c) determined at 108 is distributed to a pixel 172 located at the edge of the detector 14 is weighted differently than pixels 174 and 176 which are not located at the edge of the detector 14.

It should be realized that after the difference value ε/n has been distributed to the neighboring pixels at 110, that some of the neighboring pixels may now have a negative output value. For example, referring again to FIG. 4, assume that the MPF mapping function has been performed on the pixel 162 in accordance with step 106. Moreover, assume that the difference between the MPF_{Output} and the MPF_{Input} for pixel 162, has been determined in accordance with step 108. The pixel 162 may have an MPF_{Output} that is positive, but still less than the ε/4. Thus, when the difference value (ε/4), which is always negative, is distributed from the pixel 160 to the pixel 162, the new value of the pixel 162 may become negative.

Therefore, in one embodiment, at 112, the method steps of 106-110 are iteratively repeated for each of the detector elements 20, i.e. the pixels, until MPF_{Output} from each of the detector elements, after the error distribution, is a positive value. Optionally, at 112 the method steps of 106-110 are iteratively repeated for a predetermined quantity of cycles that is selected by the operator. In the exemplary embodiment, the preprocessing steps 106-110 are utilized to remove shading artifacts from the pre-processed projection data.

At 114, after the preprocessed CT projection data has been filtered using the MPF filter, the filtered projection data is used to generate a sinogram.

At 116, a smoothing operation is performed on the sinogram. In the exemplary embodiment, the smoothing is performed in raw data space on the sinogram instead of in the attenuation space. The raw counts, e.g., the raw projection data, are smoothed in three-dimensions which include row, channel and view direction. The smoothing filter may be adaptively determined by the signal level. The smoothed and filtered data is combined with the raw data to generate the final smoothed data. A mixing weighting factor is determined as a function of the raw count. This function is designed in such a way that the noise in the final smoothed data monotonically increases as the x-ray flux drops. In operation, the smoothing algorithm initially prepares the detector output signal to avoid a mean shift in the following pre-processing steps. The smoothing algorithm smooths the raw data in an adaptive manner in 3D space to avoid noise amplification which may be caused by a negative log operation. In the exemplary embodiment, the smoothing algorithm utilizes the raw detector signal, rather than the normalized pre-log or post-log signals. The raw count adaptive smoothing ensures that the smoothing only takes effect when there are too few x-rays. Thus, the smoothing algorithm avoids over-smoothing large patient images as is done by most normalized-signal based smoothing algorithms.

At 118, a minus logarithmic operation is performed on the smoothed CT projection data. In the exemplary embodiment, the minus logarithmic operation is utilized to generate information that is then used at 120 to reconstruct an image of the patient 22

A technical effect of at least one embodiment described herein is to facilitate improving the quality of images generated from a CT scan. Various embodiments described herein utilize and MPF filter improve image quality by compensating for photon starvation conditions. Various embodiments also improve the quality of CT images by reducing or mitigating low signal artifacts and thus enable lower dose CT scans to be performed.

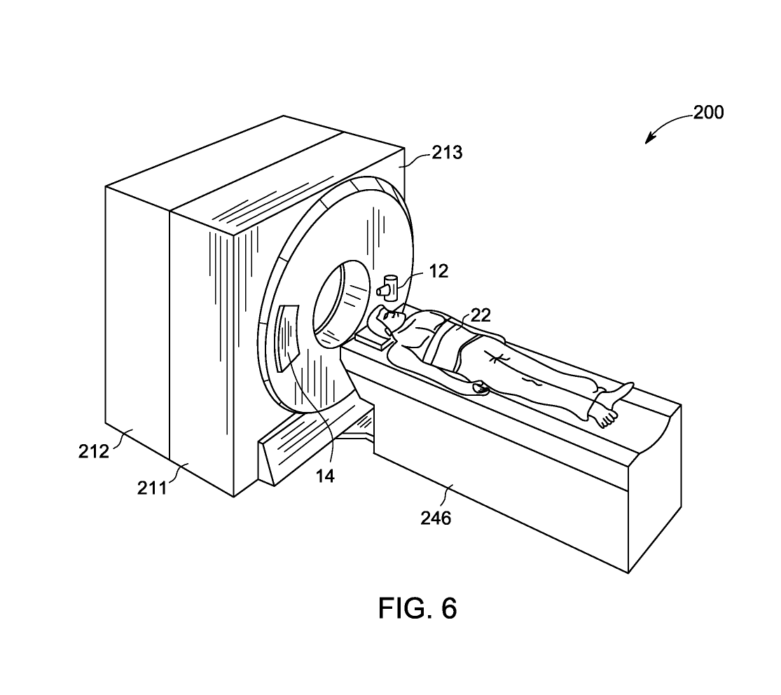

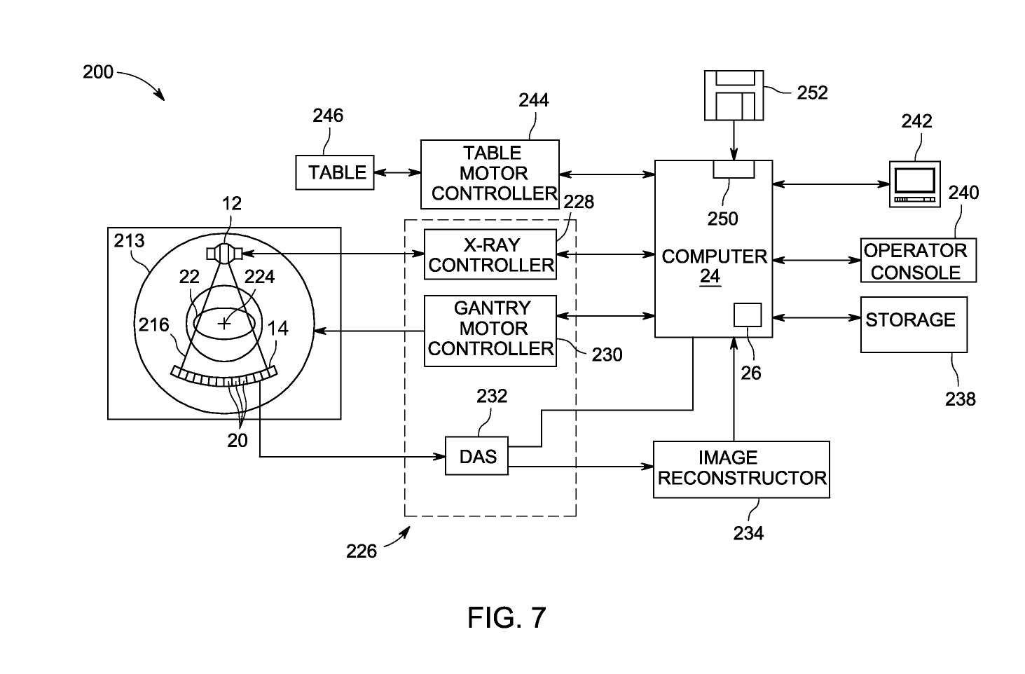

FIG. 6 is a pictorial view of an exemplary multi-modality imaging system 200 that is formed in accordance with various embodiments. FIG. 7 is a block schematic diagram of the multi-modality imaging system 200 illustrated in FIG. 6. Although various embodiment are described in the context of an exemplary dual modality imaging system that includes a CT imaging system and a PET imaging system, it should be understood that other imaging systems capable of performing the functions described herein are contemplated as being used.

Referring to FIGS. 6 and 7, a multi-modality imaging system 200 is illustrated, and includes a first modality unit 211 and a second modality unit 212. The two modality units, 211 and 212, enable system 200 to scan the patient 22 in a first modality using the first modality unit 211 and to scan the patient 22 in a second modality using the second modality unit 212. The system 200 allows for multiple scans in different modalities to facilitate an increased diagnostic capability over single modality systems. In one embodiment, the multi-modality imaging system 200 is a Positron Emission Tomography/Computed Tomography (PET/CT) imaging system 200. Optionally, modalities other than CT and PET are employed with system 200. The first modality unit 211, e.g. the CT imaging system, includes a gantry 213 that has the x-ray source 12 that projects a beam of x-rays 216 toward the detector array 14 on the opposite side of the gantry 213. The detector array 14 includes a plurality of detector elements 20, that are arranged in rows and channels, that together sense the projected x-rays that pass through an object, such as a medical patient 22.

Each detector element 20 produces an electrical signal, or output, that represents the intensity of an impinging X-ray beam and hence allows estimation of the attenuation of the beam as it passes through object or patient 22. During a scan to acquire x-ray projection data, the gantry 213 and the components mounted thereon rotate about a center of rotation 224. FIG. 7 shows only a single row of detector elements 20 (i.e., a detector row). However, the multislice detector array 14 includes a plurality of parallel detector rows of detector elements 20 such that projection data corresponding to a plurality of slices can be acquired simultaneously during a scan.

Rotation of the gantry 213 and the operation of the x-ray source 12 are governed by a control mechanism 226 of PET/CT system 200. The control mechanism 226 includes an x-ray controller 228 that provides power and timing signals to the x-ray source 12 and a gantry motor controller 230 that controls the rotational speed and position of the gantry 213. A data acquisition system (DAS) 232 in the control mechanism 226 samples analog data from detector elements 20 and converts the data to digital signals for subsequent processing. An image reconstructor 234 receives the sampled and digitized x-ray data from the DAS 232 and performs high-speed image reconstruction. The reconstructed image is applied as an input to the computer 24 that stores the image in a storage device 238. Optionally, the computer 24 may receive the sampled and digitized x-ray data from the DAS 232 and perform, filtering, smoothing, and high-speed image reconstruction using the image artifact reducing module 26. In another embodiment, the image reconstruction module may be installed in the reconstructor 234. The computer 24 also receives commands and scanning parameters from an operator via console 240 that has a keyboard. An associated visual display unit 242 allows the operator to observe the reconstructed image and other data from computer.

The operator supplied commands and parameters are used by the computer 24 to provide control signals and information to the DAS 232, the x-ray controller 228 and the gantry motor controller 230. In addition, the computer 24 operates a table motor controller 244 that controls a motorized table 246 to position the patient 22 in the gantry 213. Particularly, the table 246 moves at least a portion of the patient 22 through a gantry opening 248.

In one embodiment, the computer 24 includes a device 250, for example, a floppy disk drive, CD-ROM drive, DVD drive, magnetic optical disk (MOD) device, or any other digital device including a network connecting device such as an Ethernet device for reading instructions and/or data from a computer-readable medium 252, such as a floppy disk, a CD-ROM, a DVD or an other digital source such as a network or the Internet, as well as yet to be developed digital means. In another embodiment, the computer 24 executes instructions stored in firmware (not shown). The computer 24 is programmed to perform functions described herein, and as used herein, the term computer is not limited to just those integrated circuits referred to in the art as computers, but broadly refers to computers, processors, microcontrollers, microcomputers, programmable logic controllers, application specific integrated circuits, and other programmable circuits, and these terms are used interchangeably herein.

In the exemplary embodiment, the x-ray source 12 and the detector array 14 are rotated with the gantry 213 within the imaging plane and around the patient 22 to be imaged such that the angle at which the x-ray beam 216 intersects the patient 22 constantly changes. A group of x-ray attenuation measurements, i.e., projection data, from the detector array 14 at one gantry angle is referred to as a “view”. A “scan” of the patient 22 comprises a set of views made at different gantry angles, or view angles, during one revolution of the x-ray source 12 and detector 14.

In a CT scan, the projection data is processed to reconstruct an image that corresponds to a two dimensional slice taken through the patient 22. One method for reconstructing an image from a set of projection data is referred to in the art as the filtered back projection technique. This process converts the integral attenuation measurements into an image representing attenuation of the patient in each pixel. The attenuation measurements are typically converted into units of CT numbers or Hounsfield units.

To reduce the total scan time, a “helical” scan may be performed. To perform a “helical” scan, the patient 22 is moved while the data for the prescribed number of slices is acquired. Such a system generates a single helix from a fan beam helical scan. The helix mapped out by the fan beam yields projection data from which images in each prescribed slice may be reconstructed. Multiple helices are obtained using a multi-slice detector

Reconstruction algorithms for helical scanning typically use helical weighing algorithms that weight the collected data as a function of view angle and detector channel index. Specifically, prior to the filtered back projection process, the data is weighted according to a helical weighing factor that is a function of both the gantry angle and detector angle. The weighted data is then processed to generate CT numbers and to construct an image that corresponds to a two dimensional slice taken through the patient 24. During operation of multi-slice PET/CT system 200, multiple projections are acquired simultaneously with multiple detector rows. Similar to the case of helical scan, weighting functions are applied to the projection data prior to the filtered back projection process.

Exemplary embodiments of a multi-modality imaging system are described above in detail. The multi-modality imaging system components illustrated are not limited to the specific embodiments described herein, but rather, components of each multi-modality imaging system may be utilized independently and separately from other components described herein. For example, the multi-modality imaging system components described above may also be used in combination with other imaging systems.

As used herein, the term “computer” may include any processor-based or microprocessor-based system including systems using microcontrollers, reduced instruction set computers (RISC), application specific integrated circuits (ASICs), logic circuits, and any other circuit or processor capable of executing the functions described herein. The above examples are exemplary only, and are thus not intended to limit in any way the definition and/or meaning of the term “computer”.

The computer or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes of the various embodiments of the invention. The set of instructions may be in the form of a software program. The software may be in various forms such as system software or application software. Further, the software may be in the form of a collection of separate programs, a program module within a larger program or a portion of a program module. The software also may include modular programming in the form of object-oriented programming. The processing of input data by the processing machine may be in response to user commands, or in response to results of previous processing, or in response to a request made by another processing machine.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional elements not having that property.

Also as used herein, the phrase “reconstructing an image” is not intended to exclude embodiments of the present invention in which data representing an image is generated, but a viewable image is not. Therefore, as used herein the term “image” broadly refers to both viewable images and data representing a viewable image. However, many embodiments generate, or are configured to generate, at least one viewable image.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose the various embodiments of the invention, including the best mode, and also to enable any person skilled in the art to practice the various embodiments of the invention, including making and using any devices or systems and performing any incorporated methods. The patentable scope of the various embodiments of the invention is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

What is claimed is:

1. A method for reducing imaging artifacts, said method comprising:
preprocessing a computed tomography (CT) projection data set to generate preprocessed CT projection data;
filtering the preprocessed CT projection data using a mean-preserving filter (MPF) to reduce electronic noise;
generating a sinogram using the filtered CT projection data;
performing a minus logarithmic operation on the sinogram to generate a noise corrected image; and
displaying the noise corrected image on a display.

2. The method of claim 1 further comprising:
smoothing the filtered projection data; and
generating the sinogram using the smoothed filtered projection data.

3. The method of claim 1 further comprising using the MPF filter to identify low signals in the CT projection data and replacing the low signals with a predetermined value.

4. The method of claim 1, wherein the MPF filter includes a mapping function, the method further comprising utilizing the mapping function to identify negative signals in the CT projection data and assigning a predetermined positive value to the identified negative signals.

5. The method of claim 1, wherein the MPF filter has an input receiving the preprocessed CT projection data and an output, the method further comprising utilizing the mapping function to identify low signals in the CT projection data and assign a predetermined positive value to the identified low signals.

6. The method of claim 1, wherein the MPF filter has an input receiving preprocessed CT projection data including signals having positive values and negative values, the method further comprising assigning a predetermined positive value to any negative signals, and if the signal has a positive value, the MPF filter outputs the same positive value.

7. The method of claim 1 further comprising using the MPF filter to identify low signals having a value that is greater than a predetermined noise threshold, and replacing the low signals greater than the predetermined noise threshold with a positive predetermined value.

8. The method of claim 1 further comprising:
calculating a difference value using an MPF filter input and an MPF filter output; and
distributing the difference value to a plurality of neighboring detector channels.

9. The method of claim 1 further comprising:
calculating a difference value using an MPF filter input and an MPF filter output; and
distributing a first difference value to a plurality of neighboring detector channels that are spaced away from an edge of a detector; and
distributing a different second value to a plurality of neighboring detector channels that are located at an edge of the detector.

10. An image artifact reducing module that is programmed to:
receive preprocessed computed tomography (CT) projection data including a plurality of detector output signals;
filter the preprocessed CT projection data using a mean-preserving filter (MPF) to reduce electronic noise;
generate a sinogram using the filtered CT projection data; and
perform a minus logarithmic operation on the sinogram to generate a noise corrected image.

11. The image artifact reducing module of claim 10 further programmed to:
smooth the filtered projection data; and
generate the sinogram using the smoothed filtered projection data.

12. The image artifact reducing module of claim 10 further programmed to utilize a mapping function to identify negative signals in the CT projection data, and assign a predetermined positive value to the identified negative signals.

13. The image artifact reducing module of claim 10 wherein the MPF filter has an input receiving the detector signals having positive values and negative values, the image correction module further programmed to assign a predetermined positive value to any negative detector signals, and if the detector signal has a positive value, the MPF filter outputs the same positive value.

14. The image artifact reducing module of claim 10 further programmed to identify low signals having a value that is greater than a predetermined noise threshold, and replace the low signals greater than the predetermined noise threshold with a positive predetermined value.

15. The image artifact reducing module of claim 10 further programmed to:
calculate a difference value using an MPF filter input and an MPF filter output; and
distribute the difference value to a plurality of neighboring detector channels.

16. The image artifact reducing module of claim 10 further programmed to:
calculate a difference value using an MPF filter input and an MPF filter output;
distribute a first difference value to a plurality of neighboring detector channels that are spaced away from an edge of a detector; and
distribute a different second value to a plurality of neighboring detector channels that are located at an edge of the detector.

17. A multi-modality imaging system comprising a first modality unit, a second modality unit, and a computer operationally coupled to the first and second modality units, wherein the computer is programmed to:
receive preprocessed computed tomography (CT) projection data including a plurality of detector output signals;
filter the preprocessed CT projection data using a mean-preserving filter (MPF) to reduce electronic noise;
generate a sinogram using the filtered CT projection data; and
perform a minus logarithmic operation on the sinogram to generate a noise corrected image.

18. The multi-modality imaging system of claim 17, wherein the computer is further programmed to:
smooth the filtered projection data; and
generate the sinogram using the smoothed filtered projection data.

19. The multi-modality imaging system of claim 17, wherein the computer is further programmed to identify low signals having a value that is greater than a predetermined noise threshold, and replace the low signals greater than the predetermined noise threshold with a positive predetermined value.

20. The multi-modality imaging system of claim 17, wherein the computer is further programmed to:
calculate a difference value using an MPF filter input and an MPF filter output;
distribute a first difference value to a plurality of neighboring detector channels that are spaced away from an edge of a detector; and
distribute a different second value to a plurality of neighboring detector channels that are located at an edge of the detector.
